(19) United States
(12) Patent Application Publication
(10) Pub. No.: US 2008/0038679 A1
(43) Pub. Date: Feb. 14, 2008

(54) DEVELOPING AGENT AND MANUFACTURING METHOD THEREOF

(75) Inventor: Shuitsu Sato, Meguro-ku (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Minato-ku, Tokyo (JP); TOSHIBA TEC KABUSHIKI KAISHA, Shinagawa-ku, Tokyo (JP)

(21) Appl. No.: 11/463,066

(22) Filed: Aug. 8, 2006

(51) Int. Cl. G03C 5/00

(52) U.S. Cl. 430/331

(57) ABSTRACT

A developing agent contains a toner particle having a substantially spherical polymer phase selected from any one of acrylic bases, styrene bases or styrene-acrylic bases and a polyester based resin phase to coat the polymer phase such that at least a part thereof is exposed. It becomes possible to improve the low temperature fixability, by using the developing agent.

### BACKGROUND OF THE INVENTION

1. Field of the Invention

The present invention relates to a developing agent which is used in image forming devices, for example, copiers and printers and to a manufacturing method thereof.

2. Description of the Related Art

In general, in an image forming device, an electrical latent image is first formed on an electrostatic latent image carrier such as a photoreceptor. This latent image is developed with a toner. The developed toner image is transferred onto a transfer material such as paper. An image is then formed through fixation by heating or pressurization or the like. A toner particle which is used for the image formation is mixed with a carrier particle and used as a two-component system developing agent. Alternatively, a magnetic toner particle or a non-magnetic toner particle is used as a single-component system developing agent in a single body.

In general, a toner particle is constituted of materials including a resin which becomes a binder, a coloring agent, a release agent such as waxes, and a charge inhibitor. In recent years, a polymerization method such as an emulsion polymerization coagulation method and a suspension polymerization method is employed as a formation method of a toner particle. According to the polymerization method, it can be expected to suppress a lowering of the developability and deterioration of the image quality by controlling the shape or surface composition of a toner particle through selection of a condition such as heating temperature.

On the other hand, from the viewpoint of saving energy, there is required a toner from which a sufficient fixing strength is obtained at a low fixing temperature. For that reason, a material having a low glass transition point is desired as the binder resin. However, in order to obtain preservation stability, there is a lower limit in the glass transition point. Accordingly, sharp melt properties of the binder resin are required for the purpose of making both the low-temperature fixability and the preservation stability compatible with each other.

A polyester resin is excellent in the sharp melt properties as compared with a styrene-acrylic resin which is generally used as the binder resin. However, since the preparation of a fine particle dispersion of the polyester resin is difficult, it is difficult to form a toner containing a polyester resin as a binder by a polymerization method.

Then, JP-A-2004-294105 proposes a technology of dispersing and coagulating a resin solution having a polyester resin and a styrene-acrylic resin dissolved in an organic solvent in an aqueous medium, thereby forming a toner particle in which the polyester resin and the styrene-acrylic resin are mixed. Such a measure involves problems that in fact, the polyester resin and the styrene-acrylic resin coexist so that it is difficult to control the distribution of the respective resin phases; and that sufficient sharp melt properties cannot be obtained.

### SUMMARY OF THE INVENTION

An object of the invention is to provide a developing agent which can be formed by a polymerization method and which is able to improve the low-temperature fixability and a manufacturing method thereof.

According to one embodiment of the invention, there is provided a developing agent comprising a toner particle having a substantially spherical polymer phase selected from any one of acrylic bases, styrene bases or styrene-acrylic bases and a polyester based resin phase to coat the polymer phase such that at least a part thereof is exposed.

Also, according to another embodiment of the invention, there is provided a manufacturing method of a developing agent comprising dissolving a soluble resin containing a polyester based resin in an organic solvent containing an acrylic and/or styrene based monomer and from 25 to 70 wt % of a crosslinkable monomer, dispersing the organic solvent having the soluble resin dissolved therein in an aqueous solvent and suspension polymerizing the acrylic monomer in the dispersed organic solvent.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE DRAWINGS

FIG. 1 is a microscopic photograph of a toner particle in one embodiment of the invention.

FIG. 2 is a table showing evaluation results regarding the fixability, preservability, storability and fluidity in the Examples and Comparative Example of the invention.

### DETAILED DESCRIPTION OF THE EMBODIMENTS

The developing agent according to one embodiment of the invention contains a toner particle having a substantially spherical polymer phase selected from any one of acrylic bases, styrene bases or styrene-acrylic bases and a polyester based resin phase to coat the polymer phase such that at least a part thereof is exposed.

Also, the manufacturing method of a developing agent according to another embodiment of the invention includes dissolving a soluble resin containing a polyester based resin in an organic solvent containing an acrylic and/or styrene based monomer and from 25 to 70 wt % of a crosslinkable monomer, dispersing the organic solvent having the soluble resin dissolved therein in an aqueous solvent and suspension polymerizing the acrylic monomer in the dispersed organic solvent.

Here, the polymer phase of the toner particle has a substantially spherical shape and is selected from acrylic bases, styrene bases and styrene-acrylic bases. And, for example, the polymer phase of the toner particle is formed by dissolving a polyester based resin in an organic solvent containing an acrylic or styrene based monomer, dispersing the solution in an aqueous solvent and polymerizing the dispersion. It is preferable that the monomer which is used at this time is able to dissolve the polyester based resin which constitutes the polyester based resin phase therein but does not dissolve the polyester based resin therein after the polymerization. That is, it is preferable that the monomer has high compatibility with the polyester based resin and has low compatibility with the polyester based resin after the polymerization.

The compatibility is described in Polymer Blend: Compatibility and Interface (published on Dec. 8, 1981 by CMC Publishing Co., Ltd., First Print); Polymer Data Handbook: Basic Compilation (published on Jan. 30, 1986 by Baifukan Co., Ltd., First Edition); and so on. In general, materials having a solubility parameter (SP value) as specified by

SP=[(Molar evaporation energy)/(Molar volume)]/2

close to each other have high compatibility with each other. Accordingly, for example, it is preferable that a difference in the SP value between the polyester resin and the acrylic monomer is smaller than a difference in the SP value between the polyester resin and the acrylic polymer.

As the monomer from which such compatibility can be obtained, for example, acrylic monomers including the following methacrylic or acrylic monomers can be used. Examples include α-methylene aliphatic monocarboxylic acid esters such as methyl acrylate, ethyl acrylate, n-butyl acylate, isobutyl acrylate, propyl acrylate, n-octyl acrylate, dodecyl acrylate, 2-ethylhexyl acrylate, stearyl acrylate, 2-chlorethyl acrylate, phenyl acrylate, methyl α-chloroacrylate, methyl methacrylate, ethyl methacrylate, propyl methacrylate, n-butyl meth-acrylate, isobutyl methacrylate, n-octyl methacrylate, dodecyl methacrylate, 2-ethylhexyl methacrylate, stearyl methacrylate, phenyl methacrylate, and dimethylaminoethyl acrylate; acrylic acid or methacrylic acid derivatives such as acrylonitrile, methacrylonitrile, acrylamide, methacrylamide, 2-hedroxyethyl acrylate, 2-hedroxypropyl acrylate, 2-hedroxyethyl methacrylate, 2-hedroxypropyl methacrylate, and 2-hedroxybutyl methacrylate; acrylic acid; and methacrylic acid.

These polymerizable monofunctional monomers can be respectively used singly or in combination with two or more kinds thereof. Of these, acrylic esters, methacrylic esters and derivatives thereof are preferably used.

As other monomers, hydrophilic functional group-containing vinyl based monomers such as maleic acid and fumaric acid; styrene and styrene derivatives such as styrene, o-methylstyrene, m-methylstyrene, p-methylstyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, n-methoxystyrene, p-phenylstyrene, p-chlorostyrene, and 3,4-dichlorostyrene; ethylenically unsaturated monoolefins such as ethylene, propylene, butylene, and isobutylene; vinyl halides such as vinyl chloride, vinylidene chloride, vinyl bromide, and vinyl fluoride; vinyl esters such as vinyl acetate, vinyl propionate, and vinyl butyrate; and so on can be contained singly or in combination with two or more kinds of other monomers such as acrylic monomers.

Also, it is preferable that a crosslinkable monomer is further contained. Examples of the crosslinkable monomer include polyfunctional vinyl monomers containing two or more vinyl groups in one molecule thereof, allyl group-containing polymerizable vinyl monomers, and hydrolyzable alkoxysilyl group-containing polymerizable vinyl monomers. For example, methacrytoyl group-containing monomers such as (methacryloxy)dimethylethoxysilane, γ-methacryloxytrimethoxysilane, 3-methacryloxypropyldimethylchlorosilane, and methacryloxypropyldimethylethoxysilane are preferable. These monomers are highly reactive with acrylic esters or methacrylic esters and are able to form a good binder resin phase. It is also possible to contain other monomer which is copolymerizable therewith, if desired.

The polyester based resin phase which coats the polymer phase of the toner particle such that at least a part thereof is exposed is, for example, formed by depositing on a surface of the polymer phase by phase separation in dissolving the polyester based resin in an organic solvent containing any one of the acrylic monomer and/or the styrene based monomer and a crosslinkable monomer and polymerizing the monomer containing the acrylic monomer. When such a measure is employed, it is necessary that the amount of the crosslinkable monomer in the organic solvent is from 25 to 70 wt %. When the amount of the crosslinkable monomer is less than 25 wt %, it becomes difficult to sufficiently advance the phase separation and to deposit the polyester based resin on a surface thereof such that at least a part of the polymer phase is exposed, whereas when it exceeds 70 wt %, the phase separation excessively proceeds so that the formation of a spherical toner particle becomes difficult. And, at this time, in the case of using the acrylic monomer as the monomer, its amount is preferably from 2 to 60 wt %; and in the case of using other monomer in addition to the acrylic monomer, the amount of other monomer is preferably not more than 45 wt %.

As the polyester based resin which constitutes the polyester based resin phase, a resin which is low in compatibility with the acrylic, styrene based or styrene-acrylic polymer phase but which gives high compatibility with its monomer is preferable.

As such a polyester based resin, for example, polyester based resins obtainable by the reaction of an aliphatic polyhydric alcohol and a polybasic acid and polyester based resins obtainable by the reaction of an aromatic polyhydric alcohol and a polybasic acid can be used. Concretely, VYLON® Series as manufactured by Toyobo Co., Ltd. can be suitably used.

A polystyrene based resin obtainable by the polymerization or copolymerization of a monomer containing styrene as the major component can also be properly contained. In addition, a non-crosslinked polymer of, for example, an acrylic ester or a methacrylic ester, acrylonitrile, or maleic anhydride may be contained. As this time, the polymerization method is not particularly limited, and suspension polymerization, block polymerization, emulsion polymerization, or the like can be employed. These resin and polymer are dissolved in the foregoing monomer-containing organic solvent likewise the polyester based resin.

Such a polyester resin-containing soluble resin is dissolved in the foregoing monomer-containing organic solvent. At this time, the amount of the soluble resin is from 5 to 50 wt % based on the total amount of the polyester based resin-containing soluble resin and the monomer-containing organic solvent, preferably. When the amount of the soluble resin exceeds 50 wt %, the viscosity increases so that it becomes difficult to dissolve the soluble resin in the organic solvent and to use it. On the other hand, when it is less than 5 wt %, it becomes difficult to sufficiently coat the surface of the toner particle by the polyester based resin phase.

And, the organic solvent having the soluble resin dissolved therein is dispersed in an aqueous solvent. At this time, in order to design to stabilize the dispersed suspended particle, it is possible to add a dispersion stabilizer in the aqueous solvent. Examples of the dispersion stabilizer which can be used include phosphoric acid salts such as calcium phosphate, magnesium phosphate, aluminum phosphate, and zinc phosphate; pyrophosphoric acid salts such as calcium pyrophosphate, magnesium pyrophosphate, aluminum pyrophosphate, and zinc pyrophosphate; and sparingly water-soluble inorganic compounds such as calcium carbonate, calcium hydroxide, magnesium hydroxide, aluminum hydroxide, calcium metasilicate, calcium sulfate, barium sulfate, and colloidal silica.

In addition, a surfactant such as anionic surfactants, cationic surfactants, ampholytic surfactants, and nonionic surfactants can be used jointly. Examples of the anionic surfactant which can be used include fatty acid oils such as sodium oleate and potassium castor oil; alkyl sulfuric acid ester salts such as sodium lauryl sulfate and ammonium lauryl sulfate; alkylbenzenesulfonic acid salts such as sodium dodecylbenzenesulfonate; alkylnaphthalenesulfonic acid salts; alkanesulfonic acid salts; dialkylsulfosuccinic acid salts; alkylphosphoric ester salts; naphthalenesulfonic acid-formalin condensates, polyoxyethylene alkylphenyl ether sulfuric acid ester salts; and polyoxyethylene alkyl sulfuric acid ester salts. Furthermore, examples of the cationic surfactant which can be used include alkylamine salts such as laurylamine acetate and stearylamine acetate; and quaternary ammonium salts such as lauryltrimethylaluminum chloride. Furthermore, examples of the ampholytic surfactant which can be used include lauryldimethylamine oxide. Furthermore, examples of the nonionic surfactant which can be used include polyoxyethylene alkyl ethers, polyoxyethylene alkylphenyl ethers, polyoxyethylene fatty acid esters, sorbitan fatty acid esters, polyoxysorbitan fatty acid esters, polyoxyethylene alkylamines, glycerin fatty acid esters, and oxyethylene-oxypropylene block polymers.

And, the acrylic monomer-containing monomer in the organic solvent as dispersed in the aqueous solvent is polymerized by a suspension polymerization method or the like. At this time, a polymerization initiator can be used, if desired. As the polymerization initiator, an oil-soluble peroxide based or azo based initiator which is usually used in the suspension polymerization can be used. Useful examples thereof include peroxide based initiators such as benzoyl peroxide, lauroyl peroxide, octanoyl peroxide, benzoyl orthochloroperoxide, benzoyl orthomethoxyperoxide, methyl ethyl ketone peroxide, diisopropyl peroxydicarbonate, cumene hydroperoxide, cyclohexanone peroxide, t-butyl hydroperoxide, and diisopropylbenzene hydroperoxide; 2,2′-azobisiso-butyronitrile; 2,2′-azobis(2,4-dimethylvaleronitrile); 2,2′-azobis(2,3-dimethylbutyronitrile); 2,2′-azobis(2-methylbutyronitrile); 2,2′-azobis(2,3,3-trimethylbutyronitrile); 2,2′-azobis(2-isopropylbutyronitrile); 1,1′-azobiscyclohexane-l-carbonitrile; 2,2′-azo-bis(4-methoxy-2,4-dimethylvaleronitrile); 2-(carbbamoylazo)isobutyronitrile; 4,4′-azobis(4-cyanovaleric acid); and dimethyl-2,2′-azobisisobutyrate. In particular, by using 2,2′-azobisisobutyronitrile or 2,2′-azobis(2,4-dimethylvaleronitrile), it is possible to form a good binder resin phase. The amount of such a polymerization initiator is preferably from 0.01 to 10 wt % based on the total amount of the monomers.

Furthermore, for the purposes of inhibiting the polymerization of the monomers in the aqueous solvent, promoting the phase separation within a droplet and forming a good binder resin phase, from 0.01 to 1 wt % of a water-soluble polymerization inhibitor may be added in the aqueous solvent. The water-soluble polymerization inhibitor is not particularly limited, and for example, nitrous acid salts and hydroquinone can be used.

In addition, a coloring agent which is contained in the toner particle is mixed in the aqueous solvent. Known dyes or pigments can be used as the coloring agent.

With respect to an inorganic pigment, for example, carbon blacks such as furnace black, channel black, acetylene black, thermal black, and lamp black; and magnetic powders such as magnetite and ferrite can be used as a black pigment which is used in a black toner pigment.

Furthermore, with respect to an organic pigment, for example, C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, and C.I. Pigment Red 222 can be used as a magenta or red pigment which is used in a magenta toner particle.

Furthermore, for example, C.I. Pigment Orange 31, C.I. Pigment Orange 43, C.I. Pigment Yellow 12, C.I. Pigment Yellow 13, C.I. Pigment Yellow 14, C.I. Pigment 15, C.I. Pigment Yellow 17, C.I. Pigment Yellow 93, C.I. Pigment Yellow 94, C.I. Pigment Yellow 138, C.I. Pigment Yellow 180, C.I. Pigment Yellow 185, C.I. Pigment Yellow 155, and C.I. Pigment Yellow 156 can be used as an orange or yellow pigment which is used in a yellow toner particle.

Furthermore, for example, C.I. Pigment Blue 15, C.I. Pigment Blue 15:2, C.I. Pigment Blue 15:3, C.I. Pigment Blue 16, C.I. Pigment Blue 60, and C.I. Pigment Green 7 can be used as a green or cyan pigment which is used in a cyan toner particle.

Furthermore, C.I. Solvent Red 1, C.I. Solvent Red 49, C.I. Solvent Red 52, C.I. Solvent Red 58, C.I. Solvent Red 63, C.I. Solvent Red 111, C.I. Solvent Red 122, C.I. Solvent Yellow 19, C.I. Solvent Yellow 44, C.I. Solvent Yellow 77, C.I. Solvent Yellow 79, C.I. Solvent Yellow 81, C.I. Solvent Yellow 82, C.I. Solvent Yellow 93, C.I. Solvent Yellow 98, C.I. Solvent Yellow 103, C.I. Solvent Yellow 104, C.I. Solvent Yellow 112, C.I. Solvent Yellow 162, C.I. Solvent Blue 25, C.I. Solvent Blue 36, C.I. Solvent Blue 60, C.I. Solvent Blue 70, C.I. Solvent Blue 93, C.I. Solvent Blue 95, and so on can be used as a dye.

Such a dye or pigment can be jointly used by selecting a single member or plural members thereamong. Furthermore, the content of the inorganic pigment in the toner particle is preferably from 2 to 20 wt %. When the content of the inorganic pigment is less than 2 wt %, a sufficient image density is not obtained at the time of forming into a toner, whereas when it exceeds 20 wt %, the dispersion into the aqueous solvent is insufficient so that the dispersibility becomes poor at the time of forming into a toner. Furthermore, the content of an individual toner varies so that a difference in the performance among the individual particles is generated. The content of the inorganic pigment is more preferably from 3 to 15 wt %. Furthermore, by using magnetite, the toner can be used as a magnetic toner. In that case, from the viewpoint of revealing a predetermined magnetic characteristic, the content of magnetite in the toner particle is preferably from 20 to 120 wt %.

Furthermore, an antistatic agent may be contained in the toner particle, if desired and is similarly mixed in the aqueous solvent. As the antistatic agent, known antistatic agents can be used. For example, fluorine based active agents, salicylic acid metals salts, and metal salts of salicylic acid derivatives can be used. Concretely, useful examples thereof include BONTRON 03 as a nigrosine based dye, BONTRON S-34 as a metal-containing azo dye, E-82 as a hydroxynaphthoic acid based metal complex, E-84 as a salicylic acid based metal complex, and E-89 as a phenol based condensate (all of which are manufactured by Orient Chemical Industries, Ltd.); COPY CHARGE PSY VP2038 as a quaternary ammonium salt, COPY BLUE PR as a triphenylmethane derivative, COPY CHARGE NEG VP2036 as a quaternary ammonium salt, and COPY CHARGE NX VP434 (all of which are manufactured by Hoechst AG); LRA-901 and LR-147 as a boron complex (all of which are manufactured by Japan Carlit Co., Ltd.); and besides, high molecular weight compounds containing a functional group such as a sulfonic acid group, a carboxyl group, and a quaternary ammonium salt.

Such an antistatic agent can be jointly used by selecting a single member or plural members thereamong. Furthermore, the content of the antistatic agent in the binder resin is preferably from 0.1 to 10 wt %. When the content of the antistatic agent is less than 0.1 wt %, the function as an antistatic agent cannot be exhibited, whereas when it exceeds 10 wt %, the dispersion into the aqueous solvent is insufficient so that the dispersibility becomes poor at the time of forming into a toner. Furthermore, the content of an individual toner varies so that a difference in the performance among the individual particles is generated. The content of the antistatic agent is more preferably from 0.2 to 2 wt %.

Furthermore, in order to bear the toner particle with release properties, a release agent such as waxes may be contained and is similarly mixed in the aqueous solvent. Taking into consideration the fixability of the toner particle, the release agent preferably has a melting point of from 40 to 120° C. When the melting point of the release agent is lower than 40° C., the preservability as a powder is deteriorated, whereas when it exceeds 120° C., it becomes difficult to fix the release agent to a transfer material at low energy. The melting point of the release agent is more preferably from 50 to 110° C. Incidentally, the melting point of the release agent can be determined by differential scanning calorimetry (DSC). When several milligrams of a sample is heated at a constant temperature rising temperature, for example, 10° C./min, its melting peak value is defined as a melting point.

Examples of such a release agent which can be used include solid paraffin waxes, micro waxes, rise waxes, fatty acid amide based waxes, fatty acid based waxes, aliphatic monoketones, fatty acid metal salt based waxes, fatty acid ester based waxes, partially saponified fatty acid ester based waxes, silicone varnishes, higher alcohols, and carnauba waxes. Polyolefins such as low molecular weight polyethylene and polypropylene can also be used.

In order to disperse such a material (dispersion medium) to be mixed in the aqueous solvent, a method of dispersing into a monomer droplet by a stirring force by a propeller blade or the like, a homomixer or an ultrasonic dispersion machine which is a dispersion machine utilizing a high shear force and being configured of a rotor and a stator, and so on are employable. The average maximum particle size of the resin particle which is formed by the polymerization relies upon not only the mixing condition of the monomer mixture and the aqueous solvent and the amount of additives such as a dispersion stabilizer but also the stirring condition, the dispersion condition, and so on. Accordingly, the particle size can be controlled by controlling these conditions. Incidentally, the particle size can be put in order by using a high pressure type dispersion machine such as a micro fluidizer or a nanomizer each utilizing a collision among the droplets or a collision force against a machine wall.

As the need arises, by heating the thus dispersed dispersion medium, the monomers can be polymerized. The polymerization temperature is preferably from 30 to 100° C., and more preferably from 40 to 80° C. And, by keeping this polymerization temperature for from about 0.1 to 10 hours, the monomers are polymerized. Meanwhile, it is preferred to achieve gentle stirring to an extent that floating of the monomer droplet or sedimentation of the resin particle after the polymerization is prevented.

After the polymerization has been carried out in this way, the dispersion stabilizer is dissolved in hydrochloric acid or the like, and the resin particle is subjected to suction filtration. In addition, a hydrated cake of the resin particle can be separated by centrifugation, centrifugal filtration, or the like. This hydrated cake is then washed with water and dried, thereby forming the toner particle.

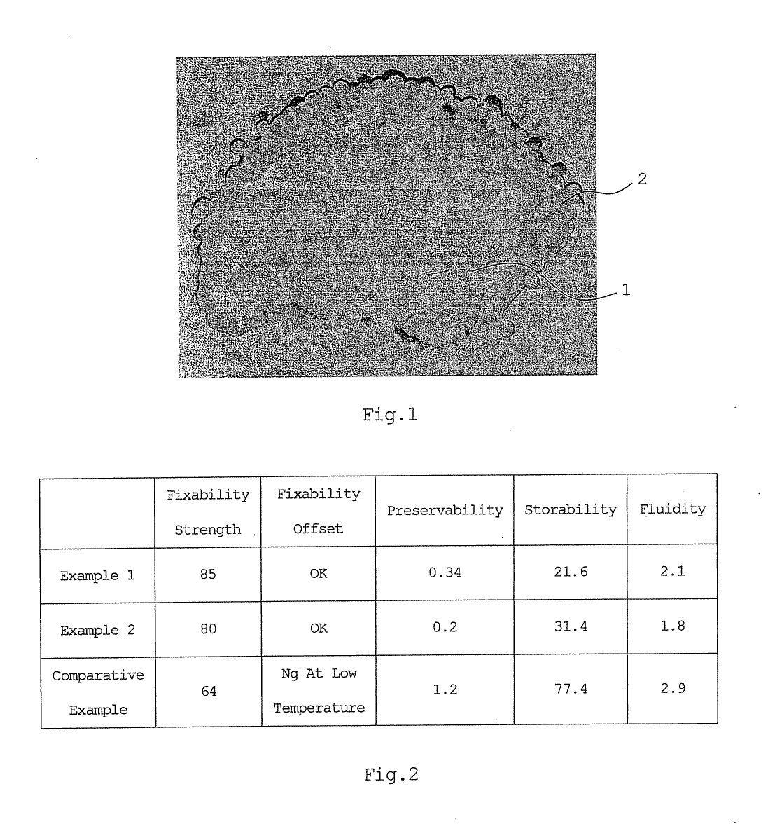

As illustrated in FIG. 1, the thus formed toner particle is in a state that while a part of an acrylic polymer phase 1 is exposed, its surface is substantially coated by a polyester based resin phase 2. The surface of the toner particle has a number of concaves and convexes and is able to contribute to an improvement of the cleaning properties. At this time, the proportion of the polyester based resin phase is preferably from 5 to 50 wt % of the binder resin phase containing the acrylic polymer phase and the polyester based resin phase. When the proportion of the polyester based resin phase exceeds 50 wt %, not only it is difficult to advance the process but also the amount of the acrylic monomer is too small, whereby the polymerization reaction becomes insufficient. On the other hand, when it is less than 5 wt %, it becomes difficult to sufficiently coat the surface of the toner particle by the polyester based resin phase so that sufficient sharp melt properties cannot be obtained.

And, for the purpose of further improving the fluidity, developability, charge properties and cleaning properties and so on, an external additive such as an inorganic fine particle may be added in the thus formed toner particle. The inorganic fine particle preferably has a primary particle size of from 5 nm to 2 μm, and more preferably from 5 nm to 500 nm. Furthermore, the inorganic fine particle preferably has a specific surface area by a BET method of from 20 to 500 m²/g. And, the content of the inorganic fine particle is preferably from 0.01 to 5 wt %, andmore preferably from 0.01 to 2 wt % of thetoner particle.

Examples of the inorganic fine particle which can be used for the purpose of improving the fluidity include silica, alumina, titanium oxide, barium titanate, magnesium titanate, calcium titanate, strontium titanate, zinc oxide, tin oxide, quartz sand, clay, mica, wollastonite, diatomaceous earth, chromium oxide, cerium oxide, red iron oxide, antimony trioxide, magnesium oxide, zirconium oxide, barium sulfate, barium carbonate, calcium carbonate, silicon carbide, and silicon nitride. Besides, high molecular weight based fine particles formed by soap-free emulsion polymerization, suspension polymerization or dispersion polymerization, such as polystyrenes, copolymers of a methacrylic ester or an acrylic ester, and polymer particles due to a polycondensation system or a thermocurable resin such as silicones, benzo-guanamines, and nylons can be used.

By carrying out a surface treatment, such an external additive is able to increase the hydrophobicity and to prevent deteriorations in the flow characteristic and charge characteristic even at a high humidity. Examples of a surface treating agent which can be used include a silane coupling agent, a silylating agent, a fluoroalkyl group-containing silane coupling agent, an induced titanate based coupling agent, an aluminum based coupling agent, a silicone oil, and a modified silicone oil.

Examples of the external additive which can be used for the purpose of improving the fluidity include inorganic fine particles such as fatty acid metal salts, for example, zinc stearate, calcium stearate, and stearic acid; and polymer fine particles formed by soap-free emulsion polymerization or the like, for example, a polymethyl methacrylate fine particle and a polystyrene fine particle. The polymer fine particle preferably has a relatively narrow particle size distribution and a volume average particle size of from 10 nm to 1 μm.

Incidentally, these materials are not limited to those as described previously but can be properly selected and used.

The invention will be specifically described below with reference to the following Examples. Incidentally, in the Examples and Comparative Example, COLTER MULTISIZER II (manufactured by Beckmann-Coulter) was used for the measurement of a volume average particle size. Furthermore, the shape and structure of particles were observed by an optical microscope and a transmission electron microscope.

### EXAMPLE 1

An aqueous solvent which had been prepared by adding, as a dispersion stabilizer, 5 wt % of magnesium pyrophosphate obtained by a double decomposition method in 200 part of water was added in a separable flask. 0.01 wt % of sodium lauryl sulfate and 0.02 wt % of sodium nitrite were then dissolved as surfactants in the aqueous solvent.

Separately, an organic solvent was formed of 22 wt % of methyl methacrylate (SP value: 9,7, SP value of polymer: 9.1) as an acrylic monomer, 50 wt % of styrene as a monomer copolymerizable therewith and 8 wt % of γ-methacryloxypropyltrimethoxysilane as a crosslinkable monomer; and 20 wt % of a polyester resin (VYLON® 200, manufactured by Toyobo Co., Ltd.) (SP value: 10.1) as a soluble resin, 0.5 wt % of 2,2′-azobis(2,4-dimethylvaleronitrile) as a polymerization initiator, 5 wt % of lauric acid as a surfactant, 10 wt % of carbon black as a black pigment, 1 wt % of a zirconium monoazo dye-containing charge inhibitor, and 4 wt % of a rice wax as a release agent were uniformly dissolved therein. The composition as obtained by dissolution was added and mixed in a separately prepared aqueous solvent.

The composition as mixed with the aqueous solvent was finely dispersed at 8000 rpm in a homomixer (ULTRA TURRAX T-25, manufactured by IKA). Next, the flask was equipped with a stirring blade, a thermometer and a reflux condenser, and after purging with nitrogen, the flask was placed in a water bath at 60° C. The temperature was then kept for 10 hours at a stirring rate of 500 rpm to undergo a polymerization reaction.

After confirming the completion of the polymerization reaction, the reaction solution was cooled, to which was then added hydrochloric acid until the pH reached about 2, thereby decomposing the dispersion stabilizer. The formed resin particle was subjected to suction filtration by a Buchner funnel using filter paper; by washing it with ion exchanged water, a decomposition product of the dispersion stabilizer was removed; and the residue was dried overnight in an oven at 60° C., thereby forming a toner particle.

The thus formed toner particle was evaluated. The volume average particle size was 7.0 μm. Furthermore, as a result of the microscopic observation, the toner particle had a substantially spherical shape in a substantial core-shell form in which a styrene-containing acrylic polymer phase (styrene-acrylic polymer phase) was formed in a substantially spherical shape, a polyester phase was coated on its surface, and the styrene-acrylic polymer phase was partially exposed on the surface of the toner particle.

### EXAMPLE 2

A toner particle was formed under the same condition as in Example 1, except for using 50 wt % of allyl methacrylate in place of 8 wt % of γ-methacryl-oxypropyltrimethoxysilane and changing the amount of lauric acid from 5 wt % to 0.1 wt %.

The formed toner particle was evaluated in the same manner as in Example 1. As a result, the toner particle was a substantially spherical particle having a volume average particle size of 6.5 μm and having concaves and convexes on its surface.

### COMPARATIVE EXAMPLE

A toner particle was formed in the same manner as in Example 2, except that the addition amount of the allyl methacrylate was set up at 8 wt %, a value of which is smaller than the defined range of the crosslinkable monomer: from 25 to 70 wt %.

The formed toner particle was evaluated in the same manner as in Example 1. As a result, the toner particle was a substantially spherical fine particle having a volume average particle size of 8.0 μm in which the polyester was present in a tabular form within the particle. It is thought that this was caused due to the matter that in the foregoing manufacturing process, the content of the crosslinkable monomer in the organic solvent was small so that the phase separation did not sufficiently proceed.

(Evaluations of Toner Performance)

2 wt % of silica which had been made hydrophobic and 1 wt % of titanium oxide were mixed in 100 wt % of the toner particle as obtained in each of Examples 1 and 2 and Comparative Example using a Henschel mixer, thereby forming a toner. Each of the toners was measured for the fixability, preservability, storability and fluidity.

(Evaluation of Fixability)

The evaluation of the fixability was carried out in the following manner. First of all, a fixing unit section of e-STUDIO600 as manufactured by Toshiba Tec Corporation was taken away, thereby separating the fixing unit section from the main body. A chart for evaluating the fixability was copied in the main body section, thereby outputting an image in which an unfixed toner was attached onto a paper substrate. The unfixed toner was fixed onto the paper substrate by a fixing unit as modified such that the temperature and the fixing rate can be varied; and what a fixing strength at 140° C. is 75% or more and low-temperature offset at 130° C. and high-temperature offset at 220° C. are not generated was defined as an index of the fixability which is satisfied with the performance as a toner. At this time, the fixing strength was judged from a ratio of image density obtained by measuring patches before and after rubbing by a fastness tester (manufactured by Daiei Kagaku Seiki Mfg., Co., Ltd.) with respect to five copies as continuously produced at a predetermined fixing rate step chart by using a Macbeth image density analyzer.

(Evaluation of Preservability)

The evaluation of the preservability was carried out in the following manner. First of all, 20 g of the toner was charged in a 100-cc wide-mouthed plastic bottle, penetrated in a water bath at 55° C. for 8 hours and then cooled to room temperature in a thermoneutral environment. POWDER TESTER (manufactured by Hosokawa Micron Corporation) was used as an analyzer, and a 42-mesh sieve was set on a vibration table. The cooled toner was slowly placed on the sieve, an input voltage to the vibration table was set up at 30 V, and the analyzer was controlled such that a vibration width of the vibration table was in the range of from 60 to 90 μm. Vibration was carried out for 10 seconds in this state, and the amount of the toner remaining on the sieve was weighed. What the amount of the toner was not more than 1 g was defined as an index of the preservability which is satisfied with the performance as a toner.

(Evaluation of Storability)

The evaluation of the storability was carried out in the following manner. First of all, 1,300 g of the toner was charged in a process cartridge of e-STUDIO600 as manufactured by Toshiba Tec Corporation and allowed to stand in a thermostat at 45° C. for 200 hours. Then, a toner replenishment mechanism of the cartridge was rotated by a process cartridge drive device, thereby discharging the toner present therein. The residual amount of the toner in the cartridge after discharging was measured. What the residual amount of the toner was not more than 65 g was defined as an index of the storability which is satisfied with the performance as a toner.

(Evaluation of Fluidity)

The evaluation of the fluidity was carried out in the following manner. POWDER TESTER (manufactured by Hosokawa Micron Corporation) was used as an analyzer, and a 60-mesh sieve, a 100-mesh sieve and a 200-mesh sieve were piled and set from the upper side in this order on a vibration table. An input voltage to a vibration table was set up at 30 V, and the analyzer was controlled such that a vibration width of the vibration table was in the range of from 60 to 90 μm. 20 g of the toner was vibrated in this state for 30 seconds, and the amount of the toner remaining on each of the sieves was weighed, from which was then determined a total amount. What the amount of the toner was not more than 3 g was defined as an index of the fluidity which is satisfied with the performance as a toner.

The results of these evaluations are shown in a table of FIG. 2. As shown in the table, it is understood that in Examples 1 and 2, good results are obtained in each of the evaluations, whereas in Comparative Example, a result which is satisfied with the performance as a toner is not obtained in each of the evaluations.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A developing agent comprising:
a toner particle, the toner particle comprising:
a substantially spherical polymer phase selected from any one of acrylic bases, styrene bases or styrene-acrylic bases; and
a polyester based resin phase to coat the polymer phase such that at least a part thereof is exposed.

2. The developing agent according to claim 1, wherein a surface of the toner particle has concaves and convexes.

3. The developing agent according to claim 1, wherein the polymer phase is constituted of a monomer containing an acrylic and/or styrene based monomer and a crosslinkable monomer.

4. The developing agent according to claim 1, wherein a proportion of the polyester based resin phase is from 5 to 50 wt % of a binder resin phase containing the polymer phase and the polyester based resin phase.

5. The developing agent according to claim 1, wherein the agent is formed by a polymerization method.

6. The developing agent according to claim 1, wherein the toner particle contains a coloring agent.

7. The developing agent according to claim 1, wherein the toner particle contains a charge inhibitor.

8. The developing agent according to claim 1, wherein the toner particle contains an inorganic fine particle as an external additive.

9. A manufacturing method of a developing agent including
dissolving a soluble resin containing a polyester based resin in an organic solvent containing an acrylic and/or styrene based monomer and from 25 to 70 wt % of a crosslinkable monomer;
dispersing the organic solvent having the soluble resin dissolved therein in an aqueous solvent; and
suspension-polymerizing the monomer in the dispersed organic solvent.

10. The manufacturing method of a developing agent according to claim 9, wherein the polyester resin has lower compatibility with a polymer of the monomer than compatibility with the monomer.

11. The manufacturing method of a developing agent according to claim 9, wherein a difference in an SP value between the polyester resin and the monomer is smaller than a difference in an SP value between the e polyester resin and a polymer of the monomer.

12. The manufacturing method of a developing agent according to claim 9, wherein the organic solvent contains a monomer copolymerizable with the monomer.

13. The manufacturing method of a developing agent according to claim 9, wherein the soluble resin contains a polymer which is soluble in the organic solvent.

14. The manufacturing method of a developing agent according to claim 13, wherein the polymer which is soluble in the organic solvent is a polystyrene based resin.

15. The manufacturing method of a developing agent according to claim 9, wherein a proportion of the soluble resin is from 5 to 50 wt % of the total amount of the organic solvent and the soluble resin.

16. The manufacturing method of a developing agent according to claim 9, wherein a dispersion stabilizer is contained in the aqueous solvent.

17. The manufacturing method of a developing agent according to claim 9, wherein the monomer is suspension polymerized by using a polymerization initiator.

18. The manufacturing method of a developing agent according to claim 9, wherein a coloring agent is dispersed in the aqueous solvent.
